(19) United States
(12) Patent Application Publication
(10) Pub. No.: US 2016/0369093 A1
(43) Pub. Date: Dec. 22, 2016

(54) FLAME RETARDANT COMPOSITION AND MOLDED ARTICLE INCLUDING THE SAME

(71) Applicant: CANON KABUSHIKI KAISHA, Tokyo (JP)

(72) Inventors: Takeshi Komuro, Matsudo-shi (JP); Katsuhiro Matsuda, Kawasaki-shi (JP); Toshinari Miura, Kawasaki-shi (JP)

(21) Appl. No.: 14/900,275

(22) PCT Filed: Jun. 19, 2014
(86) PCT No.: PCT/JP2014/066918

§ 371 Date: Dec. 21, 2015

(30) Foreign Application Priority Data
Jun. 28, 2013 (JP) 2013 - 136156

(51) Int. Cl. B32B 9/04; C08L 55/02; C08L 69/00; C09K 21/12

(52) U.S. Cl. CPC C08L 69/00; C09K 21/12; C08L 55/02; G03G 21/1619; C08L 2201/02; C08L 2201/08; C08L 2205/035; C08L 2203/20

(57) ABSTRACT

The present invention provides a flame retardant composition including a thermoplastic resin, a cellulose, a rubber having a siloxane bond, and a flame retardant agent.

### TECHNICAL FIELD

The present invention relates to a flame retardant composition.

### BACKGROUND ART

In recent years, in consideration of emission reduction of carbon dioxide and usage reduction of fossil resources which might be depleted in near future, research and development of low environmental load resins has been actively carried out using bio-renewable raw materials, and in particular, attention has been paid to the use of celluloses which occur abundantly in nature.

However, when a cellulose is compounded with a resin, although the heat resistance and the rigidity of the resin are improved, the impact strength and the flame retardancy thereof are remarkably degraded. Hence, a method for improving the impact strength and the flame retardancy has been pursued.

In order to solve the problem described above, PTL 1 has disclosed a method in which after the flame retardancy is imparted to natural fibers using boric acid or a boric acid compound, the natural fibers are compounded with a resin to form a flame retardant resin composition while a high heat resistance and a high rigidity are maintained.

According to PTL 1, an attempt was performed to improve the flame retardancy and mechanical properties, such as the impact strength and the heat resistance, of a cellulose composite thermoplastic resin. However, the flame retardancy of the disclosed resin composition was rated as UL-94 V-1, and a high flame retardancy (UL-94 5VB) required, for example, for housings of office machines could not be obtained.

### CITATION LIST

### Patent Literature

PTL 1 Japanese Patent Laid-Open No. 2007-231034

### SUMMARY OF INVENTION

Accordingly, the present invention provides a flame retardant composition having a high flame retardancy and high mechanical properties, the flame retardant composition including a thermoplastic resin, a cellulose, a rubber having a siloxane bond, and a flame retardant agent.

Hence, the present invention relates to a flame retardant composition including a thermoplastic resin, a cellulose, a rubber having a siloxane bond, and a flame retardant agent. In the flame retardant composition described above, when the weight of the flame retardant composition is set to 100 percent by weight, the content of the thermoplastic resin is 50 to 90 percent by weight, the content of the cellulose is 1 to 30 percent by weight, the content of the rubber having a siloxane bond is 3 to 20 percent by weight, and the content of the flame retardant agent is 5 to 20 percent by weight.

Further features of the present invention will become apparent from the following description of exemplary embodiments with reference to the attached drawings.

### BRIEF DESCRIPTION OF DRAWINGS

FIG. 1A is an external view showing one example of an image forming apparatus according to an embodiment.

FIG. 1B is a schematic view showing the inside of one example of the image forming apparatus according to the embodiment.

### DESCRIPTION OF EMBODIMENTS

A flame retardant composition of the present invention includes a thermoplastic resin, a cellulose, a rubber having a siloxane bond, and a flame retardant agent. Hereinafter, the thermoplastic resin is called an A component, the cellulose is called a B component, the rubber having a siloxane bond is called a C component, and the flame retardant agent is called a D component in some cases.

The flame retardant composition of the present invention has a high flame retardancy and is rated as UL-94 5VB.

The flame retardant composition of the present invention includes a thermoplastic resin. When the weight of the flame retardant composition is set to 100 percent by weight, the content of the thermoplastic resin is preferably 50 to 90 percent by weight.

As the thermoplastic resin of the present invention, for example, a polyethylene (PE), a polypropylene (PP), a polystyrene (PS), a polycarbonate (PC), a poly(ethylene terephthalate) (PET), a poly(butylene terephthalate) (PBT), a poly(lactic acid) (PLA), a poly(butylene succinate) (PBS), an acrylonitrile-butadiene-styrene copolymer compound (ABS), a styrene-acrylonitrile copolymer compound (SAN), and a polymer alloy, such as PC/ABS or PC/SAN, may be mentioned. Those resins may be used alone, or at least two types thereof may be used in combination. In particular, PC/ABS and PC/SAN are preferable.

The flame retardant composition of the present invention includes a cellulose. When the weight of the flame retardant composition is set to 100 percent by weight, the content of the cellulose is preferably 1 to 30 percent by weight and more preferably 3 to 15 percent by weight.

When the content of the cellulose is 30 percent by weight or less, the flame retardant composition can obtain sufficient impact strength and flame retardancy.

As the cellulose of the present invention, a compound primarily formed of a cellulose may be used, and any compound extracted from a plant or formed by a chemical synthesis may be used. In addition, the cellulose is not limited, for example, by the manufacturing method, the shape, and the degree of crystallization thereof. As particular examples of the cellulose, for example, there may be mentioned bamboo powder, wood powder, kenaf, flax, cotton, jute, used paper, wood pulp, microcrystalline cellulose, and microfibrillated cellulose.

Those celluloses mentioned above may be used alone, or at least two types thereof may be used in combination. In particular, a cellulose having a fiber shape and a fiber diameter of 100 μm or less is preferably used. When the fiber diameter is 100 μm or less, a molded article may be provided without degrading the appearance thereof.

In addition, a known surface treatment may be performed on the celluloses mentioned above. As a surface treatment method, for example, a sizing treatment, a silane coupling treatment, or an esterification treatment may be mentioned. Among those mentioned above, a sizing treatment and a silane coupling treatment are preferable.

The flame retardant composition of the present invention includes a rubber having a siloxane bond. When the weight of the flame retardant composition is set to 100 percent by weight, the content of the rubber having a siloxane bond is preferably 3 to 20 percent by weight and more preferably 5 to 15 percent by weight.

When the content of the rubber having a siloxane bond is set to 3 to 20 percent by weight, a high impact strength and a high flame retardancy can be obtained.

The rubber having a siloxane bond of the present invention is a rubber having a siloxane bond in a polymer structure. A rubber having a high affinity for a thermoplastic resin is preferable, and as a particular example, a silicone rubber may be mentioned, or in more particular, a silicone-acrylic-based core-shell rubber may be mentioned.

The core-shell rubber is a rubber having a core portion and a shell portion. The silicone-acrylic-based core-shell rubber has, for example, a silicone-acrylic composite rubber as the core portion and a graft layer of a vinyl-based polymer as the shell portion.

The flame retardant composition of the present invention includes a flame retardant agent. When the weight of the flame retardant composition is set to 100 percent by weight, the content of the flame retardant agent is preferably 5 to 20 percent by weight.

When the content of the flame retardant agent is set to 5 to 20 percent by weight, a high impact strength and a sufficient flame retardancy can be obtained.

As the flame retardant agent of the present invention, an organic flame retardant agent, an inorganic flame retardant agent, or a mixture therebetween may be used. A phosphorus-based flame retardant agent is preferable. As particular examples thereof, for example, there may be mentioned a phosphate ester, such as triphenyl phosphate, tricresyl phosphate, or trixylyl phosphate; or a condensed phosphate ester, such as resorcinol bis(diphenyl phosphate), bisphenol A bis(diphenyl phosphate), or resorcinol bis(di-2,6-xylyl phosphate). As a commercially available condensed phosphate ester, for example, CR-733S, CR-741, and PX-200, each manufactured by Daihachi Chemical Industry Co., Ltd., may be mentioned.

The flame retardant composition of the present invention may further include an anti-dripping agent, a pigment, a thermal stabilizer, an antioxidant, an inorganic filler, a weather resistant agent, a lubricant, a mold-releasing agent, an antistatic agent, and the like as long as the properties of the flame retardant composition are not impaired. When the weight of the flame retardant composition is set to 100 percent by weight, 20 percent by weight or less of the above additives may be contained.

The flame retardant composition of the present invention may also include a fluorinated compound. The fluorinated compound functions as an anti-dripping agent. Although the type of fluorinated compound is not particularly limited, because of good handling properties and dispersibility, a polytetrafluoroethylene (hereinafter referred to as “PTFE”), a PTFE modified with another resin, or a PTFE-containing mixture is preferably used.

When the weight of the flame retardant compound is set to 100 percent by weight, the content of the fluorinated compound (E component) included in the flame retardant composition of this embodiment is preferably 0.1 to 1.0 percent by weight. When the content is less than 0.1 percent by weight, a resin is melted and dripped from a flame-retardant test piece when a flame is brought into contact therewith, and as a result, the flame retardancy is difficult to be rated as UL-94 5BV.

In addition, in consideration of the influence on the environment, when the total flame retardant composition of this embodiment is set to 100 percent by weight, the content of the PTFE included in the composition is preferably 0.5 percent by weight or less.

For example, in the case of a fluorinated compound containing 50 percent by weight of a PTFE, when the weight of the flame retardant composition is set to 100 percent by weight, the content of the fluorinated compound is preferably set to 1.0 percent by weight or less.

Although the type of fluorinated compound (E component) used in the present invention is not particularly limited, since being excellent in handling properties and dispersibility, a polytetrafluoroethylene (hereinafter referred to as “PTFE”), a PTFE modified with another resin, or a PTFE-containing mixture is preferably used. In particular, Metablen A-3800 (trade name, manufactured by Mitsubishi Rayon Co. Ltd.), which is an acrylic resin-modified PTFE, may be mentioned.

As for the weight ratio of the flame retardant composition of the present invention, the ratio between charge amounts may be regarded as the composition ratio of the composition. Alternatively, by the measurement of a molded article by instrumental analysis using NMR, pyrolytic GC/MS, or the like, the composition ratio of the composition may also be measured.

A molded article including the flame retardant composition of the present invention may have a desired shape by molding. Although a molding method is not particularly limited, for example, a known technique, such as extrusion molding or injection molding, may be used. In particular, extrusion molding or injection molding is preferably used.

The resin included in the flame retardant composition of this embodiment may be a recovered resin. When a recovered resin is used, the flame retardant composition may be called a recycle resin. When the recycle resin is manufactured, a cellulose, a rubber having a siloxane bond, and a flame retardant agent may be added to a prepared resin.

Although a mixing method used for the addition is not particularly limited, melt-kneading performed by a kneading machine is preferable.

The recovered resin may be obtained from a recovered molded article. As the recovered molded articles, for example, housings of image forming apparatuses, camera components, housings and internal components of personal computers, housings and internal components of television sets, and water bottles may be mentioned.

The molded articles of this embodiment may be used for components, each of which is required to have flame retardancy, of image forming apparatuses, such as a copying machine, a laser beam printer, and an ink jet printer. In particular, for example, a housing accommodating a photosensitive member, a component provided around a fixing device, and a component provided around a power source may be mentioned.

In addition, the molded article may also be used as an exterior member as long as the design characteristics are not adversely influenced.

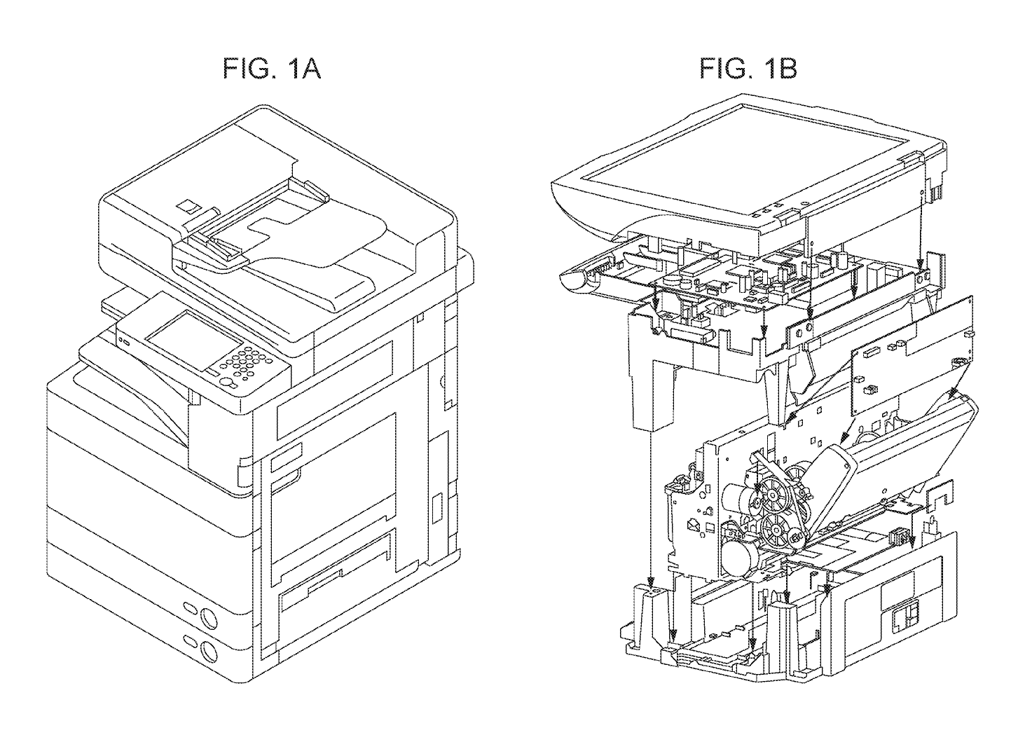

As the image forming apparatus, for example, an apparatus shown in FIGS. 1A and 1B may be mentioned. FIG. 1A is an external view showing one example of the image forming apparatus. The exterior members are shown in FIG. 1A. FIG. 1B is a schematic view showing the inside of one example of the image forming apparatus. The internal components are shown in FIG. 1B.

### EXAMPLES

### Example 1

PC/ABS (Cycoloy C1200HF manufactured by SABIC Innovative Plastics) was dried at 80° C. for 6 hours.

PC/ABS (808 g), a silicone-acrylic-based rubber (50 g, Metablen SX-005, manufactured by Mitsubishi Rayon Co. Ltd.), a condensed phosphate ester-based flame retardant agent (100 g, PX-200, manufactured by Daihachi Chemical Industry Co., Ltd.), an anti-dripping agent (10 g, Metablen A-3800, manufactured by Mitsubishi Rayon Co. Ltd.), and an antioxidant (2 g, Irganox B220, manufactured by BASF) were weighed and mixed together.

Next, melt-kneading was performed at a cylinder temperature of 240° C. to 250° C. by a biaxial extruder (Laboplasto Mill, manufactured by Toyo Seiki Seisaku-sho, Ltd.). A resin extruded from a front end of the extruder is cut into pellets, so that pellets of the resin were obtained. The pellets thus obtained were dried at 80° C. for 6 hours.

Subsequently, 970 g of the pellets described above and 30 g of a cotton powder processed with a silane coupling agent (Silquest A-1110, manufactured by Momentive Performance Materials, Inc.,) to have a content of 1 percent by weight were weighed and mixed together.

Next, melt-kneading was performed at a cylinder temperature of 200° C. to 210° C. by a biaxial extruder (Laboplasto Mill, manufactured by Toyo Seiki Seisaku-sho, Ltd.). A resin extruded from a front end of the extruder is cut into pellets, so that pellets of the resin were obtained.

After the pellets thus obtained were dried at 80° C. for 6 hours, by using an injection machine (SE18DU, manufactured by Sumitomo Heavy Industries, Ltd.), multipurpose test pieces (each having a size of 80 mm>10 mm×t (thickness) 4 mm) were molded at a cylinder temperature of 210° C. to 230° C. and at a mold temperature of 60° C., and flame-retardant test pieces (each having a size of 125 mm×12.5 mm×t 2 mm) were molded at a cylinder temperature of 210° C. to 230° C. and at a mold temperature of 40° C.

### Examples 2 to 9

Raw materials were mixed together at a mass ratio as shown in Table 1. Except for that described above, multipurpose test pieces and flame-retardant test pieces were molded using a resin in a manner similar to that in Example 1.

### Comparative Examples 1 to 3

Raw materials were mixed together at a mass ratio as shown in Table 1. Except for that described above, multipurpose test pieces and flame-retardant test pieces were molded using a resin in a manner similar to that in Example 1.

As the materials shown in Table 1, the following materials were used.
PC/ABS “Cycoloy C1200HF” manufactured by SABIC Innovative Plastics.
Microcrystalline cellulose “Ceolus ST-100” manufactured by Asahi Kasei Chemicals Corporation.
Silane coupling agent “Silquest A-1110” manufactured by manufactured by Momentive Performance Materials, Inc.
Sizing agent “SIZEPINE K-931” manufactured by Arakawa Chemical industries, Ltd.
Silicone-acrylic-based rubber “Metablen SX-005” manufactured by Mitsubishi Rayon Co. Ltd.
Condensed phosphate ester-based flame retardant agent “PX-200” manufactured by Daihachi Chemical Industry Co., Ltd.
MBS-based rubber “Metablen C-223A” manufactured by Mitsubishi Rayon Co. Ltd.
Talc “High Micron HE5” manufactured by Takehara Chemical Industry Co., Ltd.
Anti-dripping agent “Metablen A-3800” manufactured by Mitsubishi Rayon Co. Ltd.
Antioxidant “Irganox B220” manufactured by BASF.

In addition, as the evaluation, the following tests were performed.

(1) Flame Retardancy

Test method: In accordance with the 5V test of UL-94 (125 mm vertical burning test)
Sample shape: Flame-retardant test piece (125 mm×12.5 mm×t 2 mm)

(2) Charpy Impact Strength
Test method: In accordance with JIS K 7111
Sample shape: Multipurpose test piece (80 mm×10 mm×t 4 mm)
Notch machining: The type A notch is formed using a notching tool A-3 (manufactured by Toyo Seiki Seisaku-sho, Ltd.).
Measurement device: Digital impact test machine DG-UB (manufactured by Toyo Seiki Seisaku-sho, Ltd.)

(3) Deflection Temperature Under Load
Test method: In accordance with JIS K 7191-2
Sample shape: Multipurpose test piece (80 mm×10 mm×t 4 mm)
Placement method: flat placement
Flexural stress: 1.80 MPa
Span length: 64 mm
Temperature rise rate: 120° C./h
Heat medium: silicone oil
Measurement device: HDT/VSPT test device TM-4126 (manufactured by Ueshima Seisakusho Co., Ltd.)

The mixing ratio and the evaluation results of the flame retardancy, the Charpy impact strength, the deflection temperature under load of each of Examples 1 to 9 and Comparative Examples 1 to 3 are shown in Table 1.

As apparent from Table 1, when PC/ABS, the cellulose, the rubber having a siloxane bond, and the flame retardant agent are blended together, a flame retardancy of 5VB, a Charpy impact strength of 5 kJ/m² or more, and a deflection temperature under load of 70° C. or more were obtained as the evaluation results.

On the other hand, when the rubber having a siloxane bond is not used, the 5VB test was not passed, and the Charpy impact strength was also low.

TABLE 1

| | | | Example 1 | Example 2 | Example 3 | Example 4 | Example 5 |
|---|---|---|---|---|---|---|---|
| (A) Thermoplastic | PC/ABS | Cycoloy | 81.7 | 78.7 | 73.7 | 64.2 | 64.2 |
| Resin (wt %) | | C1200HF | | | | | |
| (B) Cellulose (wt %) | Cotton Powder | No Surface | — | — | — | — | — |
| | | Treatment | | | | | |
| | | SIZEPINE K- | — | — | — | 10.5 | — |
| | | 9314 | | | | | |
| | | Content: 4 wt % | | | | | |
| | | SIZEPINE K- | — | — | — | — | — |
| | | 9314 | | | | | |
| | | Content: 8 wt % | | | | | |
| | | Silquest A-1110 | 3.0 | 6.1 | 6.1 | — | — |
| | | Content: 1 wt % | | | | | |
| | ST-100 | No Surface | — | — | — | — | — |
| | | Treatment | | | | | |
| | | SIZEPINE K- | — | — | — | — | 10.5 |
| | | 9314 | | | | | |
| | | Content: 4 wt % | | | | | |
| (C) Rubber Having | Metablen SX-005 | | 5.1 | 5.1 | 10.1 | 10.1 | 10.1 |
| Siloxane Bond (wt %) | | | | | | | |
| (D) Flame Retardant | PX-200 | | 10.1 | 10.1 | 10.1 | 15.2 | 15.2 |
| Agent (wt %) | | | | | | | |
| Total (wt %) | | | 100 | 100 | 100 | 100 | 100 |
| Additive (wt %) | MBS-based Rubber | Metablen C223A | — | — | — | — | — |
| | Talc | High Micron HE5 | — | — | — | — | — |
| | Anti-Dripping Agent | Metablen A-3800 | 1.0 | 1.0 | 1.0 | 1.0 | 1.0 |
| | Antioxidant | Irganox B220 | 0.2 | 0.2 | 0.2 | 0.2 | 0.2 |
| Total (wt %) | | | 1.2 | 1.2 | 1.2 | 1.2 | 1.2 |

| | | | | | | |
|---|---|---|---|---|---|---|
| Experimental Results | 5V Test | OK | OK | OK | OK | OK |
| | Charpy Impact Strength (kJ/m²) | 7.5 | 6.0 | 6.4 | 5.9 | 5.7 |
| | Deflection Temperature under Load | 85 | 85 | 83 | 72 | 71 |
| | (° C.) | | | | | |

| | | | | | | | Comparative | Comparative | Comparative |
|---|---|---|---|---|---|---|---|---|---|
| | | | Example 6 | Example 7 | Example 8 | Example 9 | Example 1 | Example 2 | Example 3 |
| (A) Thermoplastic | PC/ABS | Cycoloy | 71.5 | 68.1 | 68.6 | 70.1 | 74.7 | 74.7 | 71.8 |
| Resin (wt %) | | C1200HF | | | | | | | |
| (B) Cellulose | Cotton | No | — | — | 6.1 | — | 10.1 | — | — |
| (wt %) | Powder | Surface | | | | | | | |
| | | Treatment | | | | | | | |
| | | SIZEPINE | — | — | — | — | — | — | — |
| | | K-9314 | | | | | | | |
| | | Content: | | | | | | | |
| | | 4 wt % | | | | | | | |
| | | SIZEPINE | 3.2 | 6.6 | — | — | — | — | — |
| | | K-9314 | | | | | | | |
| | | Content: | | | | | | | |
| | | 8 wt % | | | | | | | |
| | | Silquest | — | — | — | 3.2 | — | — | — |
| | | A-1110 | | | | | | | |
| | | Content: | | | | | | | |
| | | 1 wt % | | | | | | | |
| | ST-100 | No | — | — | — | — | — | 10.1 | 11.3 |
| | | Surface | | | | | | | |
| | | Treatment | | | | | | | |
| | | SIZEPINE | — | — | — | — | — | — | — |
| | | K-9314 | | | | | | | |
| | | Content: | | | | | | | |
| | | 4 wt % | | | | | | | |
| (C) Rubber | Metablen SX-005 | | 10.1 | 10.1 | 10.1 | 10.7 | — | — | — |
| Having Siloxane | | | | | | | | | |
| Bond (wt %) | | | | | | | | | |
| (D) Flame | PX-200 | | 15.2 | 15.2 | 15.2 | 16.0 | 15.2 | 15.2 | 16.9 |
| Retardant Agent | | | | | | | | | |
| (wt %) | | | | | | | | | |
| Total (wt %) | | | 100 | 100 | 100 | 100 | 100 | 100 | 100 |
| Additive (wt %) | MBS- | Metablen | — | — | — | — | — | — | 10 |
| | based | C223A | | | | | | | |
| | Rubber | | | | | | | | |
| | Talc | High | — | — | — | 5.0 | — | — | — |
| | | Micron | | | | | | | |
| | | HE5 | | | | | | | |
| | Anti- | Metablen | 1.0 | 1.0 | 1.0 | 1.0 | 1.0 | 1.0 | 1.0 |
| | Dripping | A-3800 | | | | | | | |
| | Agent | | | | | | | | |
| | Antioxidant | Irganox | 0.2 | 0.2 | 0.2 | 0.2 | 0.2 | 0.2 | 0.2 |
| | | B220 | | | | | | | |
| Total (wt %) | | | 1.2 | 1.2 | 1.2 | 6.2 | 1.2 | 1.2 | 11.2 |

| | | | | | | | | |
|---|---|---|---|---|---|---|---|---|
| Experimental | 5V Test | OK | OK | OK | OK | NG | NG | NG |
| Results | Charpy Impact | 9.5 | 7.9 | 5.9 | 5.5 | 3.2 | 3.1 | 5.4 |
| | Strength (kJ/m²) | | | | | | | |
| | Deflection | 72 | 72 | 73 | 74 | 77 | 76 | 72 |
| | Temperature under | | | | | | | |
| | Load (° C.) | | | | | | | |

A flame retardant composition having a low environment load, a high flame retardancy, and high mechanical properties may be used as a molding material for office machine housings, electric/electronic components, automobile components, building components, and the like.

According to the present invention, since including a thermoplastic resin, a cellulose, a rubber having a siloxane bond, and a flame retardant agent, a flame retardant composition having a high flame retardancy and high mechanical properties can be provided. In addition, a molded article having a high flame retardancy can be provided using the flame retardant composition described above.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-136156, filed Jun. 28, 2013, which is hereby incorporated by reference herein in its entirety.

1. A flame retardant composition comprising:
a thermoplastic resin;
a cellulose;
a rubber having a siloxane bond; and
a flame retardant agent,
wherein when the weight of the flame retardant composition is set to 100 percent by weight,
the content of the thermoplastic resin is 50 to 90 percent by weight,
the content of the cellulose is 1 to 30 percent by weight,
the content of the rubber having a siloxane bond is 3 to 20 percent by weight, and
the content of the flame retardant agent is 5 to 20 percent by weight.

2. The flame retardant composition according to claim 1,
wherein when the weight of the flame retardant composition is set to 100 percent by weight, the content of the cellulose is 3 to 15 percent by weight.

3. The flame retardant composition according to claim 1,
wherein when the weight of the flame retardant composition is set to 100 percent by weight, the content of the rubber having a siloxane bond is 5 to 15 percent by weight.

4. The flame retardant composition according to claim 1,
wherein the thermoplastic resin includes at least one of PC/ABS and PC/SAN.

5. The flame retardant composition according to claim 1,
further comprising a fluorinated compound,
wherein when the weight of the flame retardant composition is set to 100 percent by weight, the content of the fluorinated compound is 0.1 to 1.0 percent by weight.

6. The flame retardant composition according to claim 1,
wherein the flame retardant composition is rated as UL-94 5VB.

7. The flame retardant composition according to claim 1,
wherein the thermoplastic resin is a recovered resin.

8. A molded article obtained by molding the flame retardant composition according to claim 1.

9. An image forming apparatus comprising:
a photosensitive member; and
a housing accommodating the photosensitive member,
wherein the housing includes the molded article according to claim 8.

10. A method for manufacturing a flame retardant composition, the method comprising:
mixing a thermoplastic resin, a cellulose, a rubber having a siloxane bond, and a flame retardant agent,
wherein when the weight of the flame retardant composition is set to 100 percent by weight, the mixing is performed so that the content of the thermoplastic resin is 50 to 90 percent by weight, the content of the cellulose is 1 to 30 percent by weight, the content of the rubber having a siloxane bond is 3 to 20 percent by weight, and the content of the flame retardant agent is 5 to 20 percent by weight.

11. The method for manufacturing a flame retardant composition according to claim 10,
further comprising mixing a fluorinated compound with the thermoplastic resin, the cellulose, the rubber having a siloxane bond, and the flame retardant agent,
wherein when the weight of the flame retardant composition is set to 100 percent by weight, the mixing is performed so that the content of the fluorinated compound in the flame retardant composition is 0.1 to 1.0 percent by weight.

12. The method for manufacturing a flame retardant composition according to claim 10,
wherein the mixing of the thermoplastic resin, the cellulose, the rubber having a siloxane bond, and the flame retardant agent is melt-kneading performed by a kneading machine.

13. A method for manufacturing a molded article, the method comprising:
preparing a flame retardant composition; and
molding the flame retardant composition,
wherein the flame retardant composition is manufactured by the method for manufacturing a flame retardant composition according to claim 10.

14. The method for manufacturing a molded article according to claim 13,
wherein the molding is extrusion molding or injection molding.
